(19) United States
(12) Patent Application Publication
(10) Pub. No.: US 2009/0128304 A1
(43) Pub. Date: May 21, 2009

(54) METHOD AND APPARATUS FOR TACTILE INTERFACE FOR REVIEWING RADIOLOGICAL IMAGES

(75) Inventors: Weidong Zhao, Gurnee, IL (US); Lawrence Folkers, Suwanee, GA (US); Rajanikanth Kanyaboina, Schaumburg, IL (US); William Fung, Buffalo Grove, IL (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/940,946

(22) Filed: Nov. 15, 2007

(51) Int. Cl. G08B 6/00

(52) U.S. Cl. 340/407.1

(57) ABSTRACT

Certain embodiments of the present invention provide a system and method for reviewing medical images using a tactile interface to display a bas-relief image. A tactile interface may provide a bas-relief representation of medical imaging data to an end-user. The tactile interface may include an array of tactile elements positioned as a grouping of cylinders arranged in a closely packed array. The cylinders may be raised or lowered independently to create a bas-relief pattern of an object within a medical image. A radiologist may utilize the bas-relief image to physically identify surfaces and edges for the images being viewed. The additional information may allow a radiologist to develop quicker and more accurate diagnoses.

### BACKGROUND OF THE INVENTION

The present invention generally relates to a system and method for reviewing radiology exams. Particularly, the present invention relates to using a tactile interface for reviewing radiological images.

Medical diagnostic imaging systems encompass a variety of imaging modalities, such as x-ray systems, computerized tomography (CT) systems, ultrasound systems, electron beam tomography (EBT) systems, magnetic resonance (MR) systems, and the like. Medical diagnostic imaging systems generate images of an object, such as a patient, for example, through exposure to an energy source, such as x-rays passing through a patient, for example. The generated images may be used for many purposes. For instance, internal defects in an object may be detected. Additionally, changes in internal structure or alignment may be determined. Fluid flow within an object may also be represented. Furthermore, the image may show the presence or absence of objects in an object. The information gained from medical diagnostic imaging has applications in many fields, including medicine and manufacturing.

Typically, radiologists currently view medical images using a two dimensional monitor that is used to simulate a three dimensional space. In viewing the simulation of three dimensional space on a two dimensional monitor, the radiologist typically relies on vision and knowledge to interpret the medical images. Attempting to rely on vision and knowledge may lead to misdiagnosis and improper treatment for the patient. Even with high resolution monitors and diagnostic imaging tools, a radiologist may desire more information about a medical image than can be supplied through visual acuity.

### SUMMARY OF THE INVENTION

Certain embodiments of the present invention provide a system and method for reviewing medical images. The system may include a display unit for displaying the medical images and an input unit for receiving input from a user. The input unit may include a computer mouse, trackball, or keyboard. The system may also include a tactile interface to display a bas-relief image of a sub-section of the medical images. In an embodiment, the tactile interface includes an array of tactile elements. The tactile elements may have a cylindrical shape. In an embodiment the tactile elements of the array of tactile elements are independently controlled. In an embodiment the tactile elements of the array of tactile elements may be raised or lowered independently. In an embodiment, the input from a user includes the selection of an object within the medical images, the object being a sub-section of the medical images to display a bas-relief image. The system may also include a computer unit for executing computer software, the computer software controlling the display of the bas-relief image on the tactile interface. In an embodiment, the computer software analyzes image data for the selected object to generate data to display the bas-relief image of the selected object. In an embodiment, the input from a user includes the manipulation of a cursor, the cursor displayed on the display unit as overlaid the medical images. In an embodiment, computer software analyzes image data for the object overlaid by the cursor generate data to display the bas-relief image of the object overlaid by the cursor.

Certain embodiments of the present invention provide for a computer-readable storage medium including a set of instructions for a computer. The set of instructions includes a receipt routine for receiving the selection of an object from a set of medical images, the object being selected by a user. In an embodiment, the set of medical images includes was generated from one of an x-ray system, a computerized tomography system, an ultrasound system, an electron beam tomography system, or a magnetic resonance system. The set of instructions includes a generation routine for generating data to create a bas-relief image of the selected object. In an embodiment the generation routine generates data to create a bas-relief image of the selected object based on three-dimensional information for the selected object. In an embodiment, the set of instructions includes a second generation routine for generating simulated three-dimensional information if three-dimensional information is not available for the selected object. The set of instructions includes a communication routine for communicating the data to create a bas-relief image of the object. In an embodiment, the set of instructions may include a creation routine for creating the bas-relief image.

Certain embodiments of the present invention provide for a computer-readable storage medium including a set of instructions for a computer. The set of instructions may include an acquisition routine for acquiring a set of medical images. In an embodiment, the acquisition routine acquires the set of medical images from one of internal memory, external memory, or a medical diagnostic imaging system. The set of instructions may also include a generation routine for generating a bas-relief map for the set of medical images, the bas-relief map containing data to create a bas-relief image for the objects of the set of medical images. In an embodiment, the generation routine for generating a bas-relief map includes processing the image data for the entire set of medical images to generate data to create a bas-relief image for available objects. The set of instructions may also include a tracking routine for tracking the location of a cursor overlaid on the set of medical images. The set of instructions may also include a communication routine for communicating data to create a bas-relief image for the objects of the set of medical images based on the objects overlaid by the cursor. In an embodiment, the communication routine communicates data to create a bas-relief image at approximately the same time objects are overlaid by the cursor. The set of instructions may further comprise a storage routine for storing the set bas-relief map and the set of medical images.

### BRIEF DESCRIPTION OF THE DRAWINGS

FIG. 1 illustrates a system for reviewing medical images in accordance with an embodiment of the present invention.

FIG. 2 illustrates two views of the tactile interface in accordance with an embodiment of the present invention.

FIG. 3 illustrates a method in accordance with an embodiment of the present invention.

FIG. 4 illustrates a method in accordance with an embodiment of the present invention.

### DETAILED DESCRIPTION OF THE INVENTION

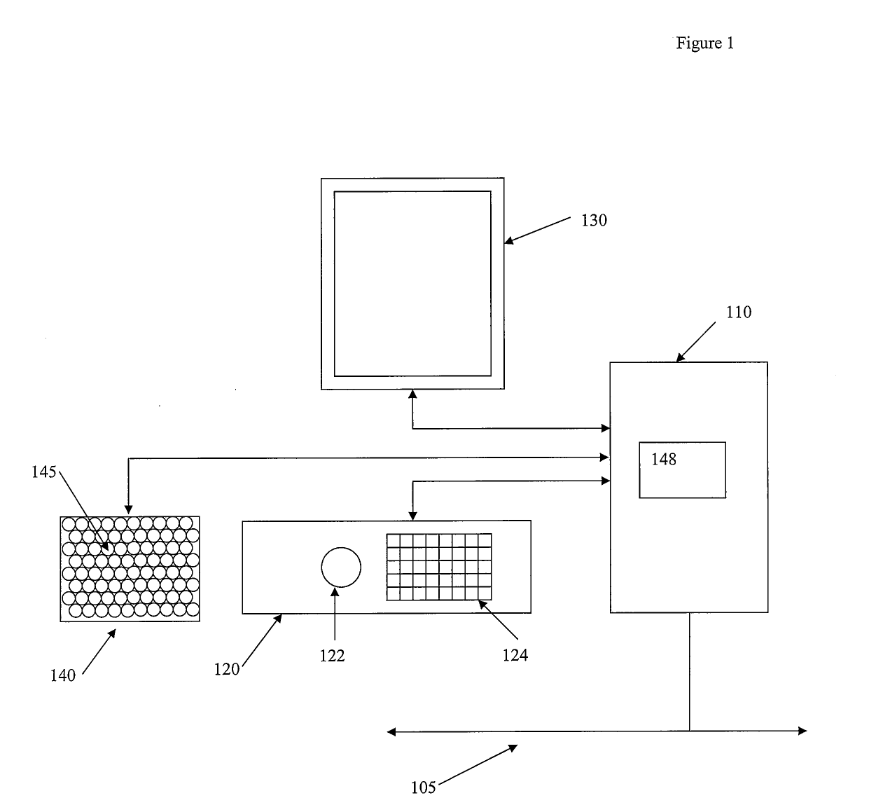

FIG. 1 illustrates a system 100 for reviewing medical images. The system 100 includes a computer unit 110. The computer unit 110 may be any equipment or software that permits electronic medical images, such as x-rays, ultrasound, CT, MRI, gated MRI, EBT, MR, or nuclear medicine for example, to be electronically acquired, stored, or transmitted for viewing and operation. The computer unit 110 may receive input from a user. The computer unit 110 may be connected to other devices as part of an electronic network. In FIG. 1, the connection to the network is represented by line 105. The computer unit 110 may be connected to network 105 physically, by a wire, or through a wireless medium. In an embodiment, the computer unit 110 may be, or may be part of, a picture archival communication system (PACS).

The system 100 also includes an input unit 120. The input unit 120 may be a console having a track ball 122 and keyboard 124. Other input devices may be used to receive input from a user as part of the input unit 120. For example a microphone may be used to receive verbal input from a user. The system 100 also includes at least one display unit 130. The display unit 130 may be a typical computer display unit. The display unit 130 may be in electrical communication with the computer unit 110 and input unit 120. In an embodiment, the display unit 130 may represent multiple display units or display regions of a screen. Accordingly, any number of display units may be utilized in accordance with the present invention.

The system 100 may also include a tactile interface 140. The tactile interface 140 may be comprised of an array of tactile elements 145. In an embodiment, the tactile elements 145 may have a cylindrical shape. The tactile elements 145 may be raised or lowered independently. The pattern in which the array of tactile elements 145 are raised or lowered can create a bas-relief image. In an embodiment, the tactile elements 145 may be raised or lowered based on electrical communication from the computer unit 110. The electrical communication from the computer unit 110 indicates the extent of displacement of the tactile elements 145 in relation to the surface of the tactile interface 140. In an embodiment, a radiologist may be able to physically identify surfaces and edges for the image(s) being viewed.

In an embodiment, the tactile interface 140 may be used to render bas-relief images of an object being displayed on display unit 130. In an embodiment, the computer unit 110 may be connected to a medical diagnostic imaging system by the network 105. In an embodiment, the medical diagnostic imaging system may include, for example, an x-ray system, a computerized tomography (CT) system, an ultrasound system, an electron beam tomography (EBT) system, or a magnetic resonance (MR) system. In an embodiment, a set of images may be generated by a medical diagnostic imaging system. Images having three-dimensional imaging data, such as images generated from an MR system, have inherent three-dimensional information. The computer unit 110 may utilize computer software, which is represented in FIG. 1 by element 148, to translate the three-dimensional information for an image to electrical input for the tactile interface 140. For images having two-dimensional imaging data, the images may be processed with computer software 148 to deduce or simulate three-dimensional information. The simulated three-dimensional information may be used by the computer software 148 as an electrical input for the tactile interface 140.

In an embodiment, the system 100 is a PACS with display unit 130 representing the display unit of PACS. The computer unit 110 may represent equipment and components of a PACS system other than the display unit. The computer unit 110 and display unit 130 may be separate units or be part of a single unit. In the case of separate units, the display unit 130 may be in electrical communication with the computer unit 110. The components of the system 100 may be single units, separate units, may be integrated in various forms, and may be implemented in hardware and/or in software.

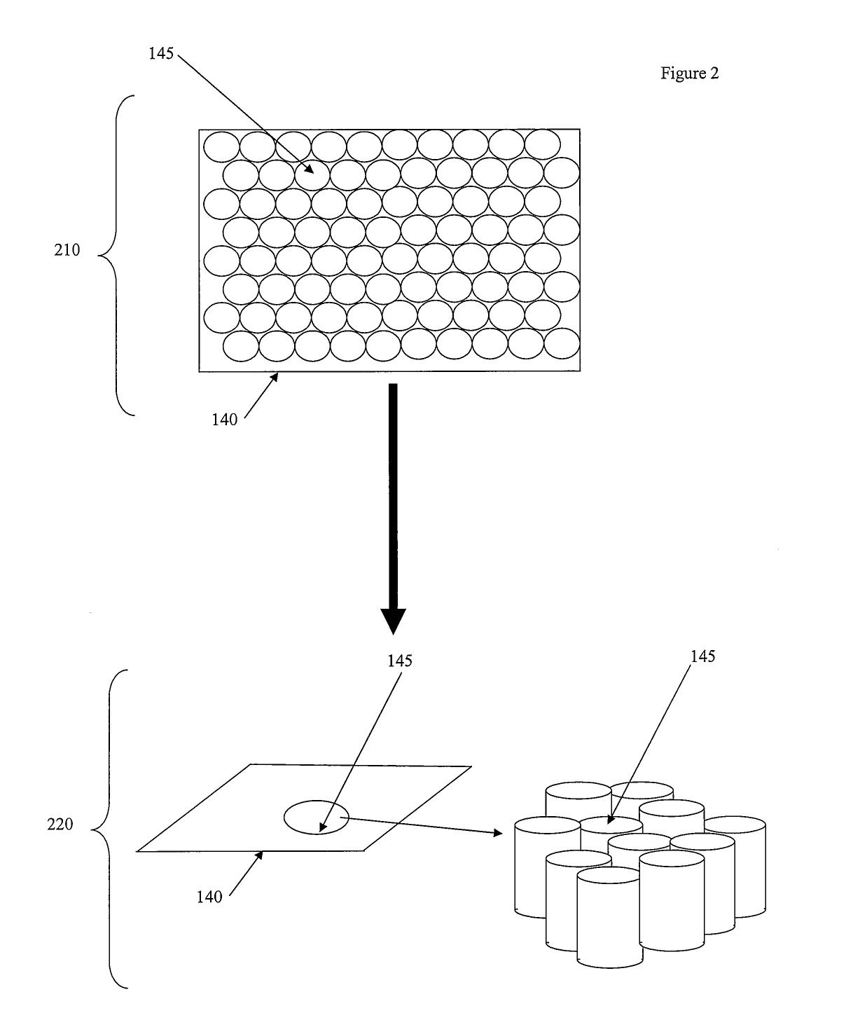

FIG. 2 illustrates two views of the tactile interface 140 in accordance with an embodiment of the present invention. View 210 illustrates a view of the tactile interface 140 and the array of tactile elements 145 looking down from above the tactile interface 140. In the embodiment shown in FIG. 2, the tactile elements are cylindrical in shape. It is contemplated, however, that any shape for the tactile elements may be used. View 220 illustrates a perspective view of a subsection of the tactile interface 140. View 220 illustrates a tactile element 145 as a cylinder. In view 220, a profile view of a group of tactile elements 145 is shown. In an embodiment, each of the tactile elements may be displaced independently. Any number of tactile elements 145 may be used to comprise a tactile interface 140.

In operation, the computer unit 110 may retrieve a set of images for review. The set of images may have been generated from a medical diagnostic imaging system, such as an x-ray system, a computerized tomography (CT) system, an ultrasound system, an electron beam tomography (EBT) system, or a magnetic resonance (MR) system. It is contemplated that a set of images from other imaging systems may be retrieved. In an embodiment, the computer unit 110 may retrieve the set of images from an external device, such as external memory, a server, or other device, over network 105. In another embodiment, the computer unit 110 may retrieve the set of images from internal memory.

In an embodiment, the computer unit 110 may display the set of images on the display unit 130. A user may manipulate the set of images by using the input unit 120. In an embodiment, if a user would like to view a bas-relief image of an object, the user may select the object using the input unit 120. An object may be selected using an on-screen cursor on the display unit 130 and a computer mouse, trackball 122, or keyboard 124.

Once an object is selected, the computer unit 110 may utilize computer software 148 to analyze the image data for the selected object. If the image data includes three-dimensional information, the computer software 148 may utilize the image data to generate data for the bas-relief image of the object. If the image data includes two-dimensional information, the computer software processes the two-dimensional information for the object to deduce or simulate three-dimensional information. The simulated three-dimensional information may be used by the computer software 148 to generate data for the bas-relief image of the object. In an embodiment, the data for the bas-relief image of the object controls the displacement of each tactile element 145. In an embodiment, each tactile element 145 is independently controlled and may be displaced as raised a certain degree or displaced as lowered to a certain degree. The computer unit 110 may communicate the data for the bas-relief image of the object to the tactile interface 140. The array of tactile elements 145 that comprise the tactile interface 140 may form a bas-relief image of the object. The bas-relief image of the object may be examined by a radiologist for three-dimensional features that otherwise may not be visible when reviewing the set of images on display unit 130.

For example, a radiologist may utilize the bas-relief image of the object to identify surfaces and edges for the selected object. The bas-relief image provides additional information for the radiologist to aid in developing a quicker and more accurate diagnosis. For example, two-dimensional or simulated three-dimensional images may not reveal the extent of a bone fracture or cancerous growth. A bas-relief image of the object in question may allow a radiologist to feel the texture, depth, and approximate size of an object. A radiologist may be able to utilize the bas-relief image to more easily distinguish objects that otherwise would appear similar.

In another embodiment of the present invention, a bas-relief image may be created on the tactile interface 140 as a user scrolls through the set of images. In an embodiment, the user may use the input unit 120 to scroll through the set of images. The user may manipulate an on-screen cursor on the display unit 130 and place the cursor over objects in the set of images. In an embodiment, a bas-relief image is generated for the object or structure the cursor is placed over on the display unit 130. In this embodiment, the user does not select an object to create the bas-image. Rather, the bas-image is generated based on the location of the cursor on the screen.

For example, a bas-relief mapping may be created for the set of images. The bas-relief mapping may include a bas-relief image for locations throughout the set of images. The bas-relief mapping may be created before a user attempts to utilize the tactile interface 140. For example, the bas-relief mapping may be created upon acquisition of the set of images by the computer unit 110. Alternatively, the bas-relief mapping may be created shortly after acquisition of the set of images from the medical diagnostic imaging system and saved with the data for the set of images. In such a manner, a user does not select an object to generate a bas-relief image. Rather, the bas-relief image of the set of images is output with the display of the set of images.

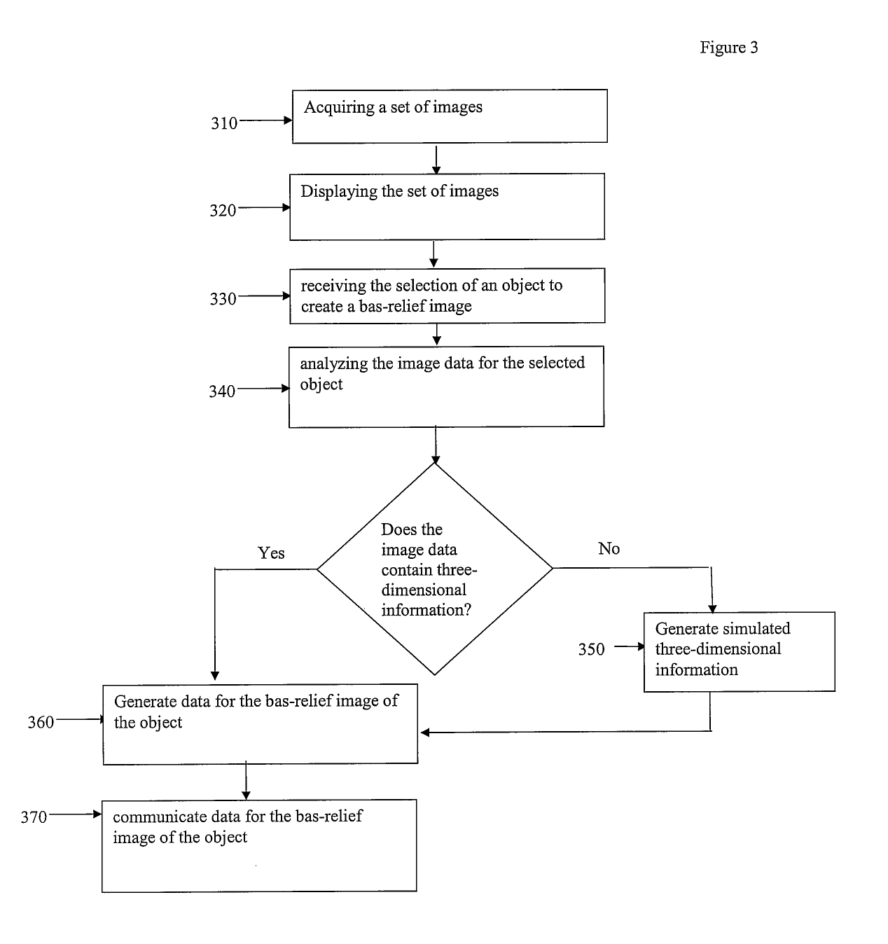

FIG. 3 illustrates a method 300 in accordance with an embodiment of the present invention. At step 310, a set of images is acquired. The set of images may have been generated from a medical diagnostic imaging system, such as an x-ray system, a computerized tomography (CT) system, an ultrasound system, an electron beam tomography (EBT) system, or a magnetic resonance (MR) system. It is contemplated that a set of images from other imaging systems may be acquired. In an embodiment, the set of images may be acquired from an external device, such as internal memory, external memory, a server, or other device.

At step 320 the set of images is displayed. The set of images may be displayed on a display unit for review by a user. A user may manipulate the images, for example reviewing various images from the set of images. While reviewing the images, a user may identify an object the user would like to gather more information about. At step 330, a user may select the object to create a bas-relief image. The user may select the object by, for example, using a computer mouse, trackball, or keyboard to select the object on-screen. The selection of the object may be received by the computer software.

At step 340, the image data for the selected object is analyzed. The image data is analyzed to determine whether the image data contains three-dimensional information. Images having three-dimensional imaging data, such as images generated from an MR system, may have inherent three-dimensional information. For images having two-dimensional imaging data, three-dimensional information may be absent from the image data. At step 360, if the image data includes three-dimensional information, the image data may be used to generate data for the bas-relief image of the object. If the image data includes two-dimensional information, as at step 350, the computer software processes the two-dimensional information for the object to deduce or simulate three-dimensional information. The simulated three-dimensional image data may then be used at step 360 to generate data for the bas-relief image of the object.

At step 370, the data for the bas-relief image of the object may be communicated to the tactile interface to create the bas-relief image. A radiologist may utilize the bas-relief image of the object to identify surfaces and edges for the selected object. The bas-relief image provides additional information for the radiologist to aid in developing a quicker and more accurate diagnosis. For example, two-dimensional or simulated three-dimensional images may not reveal the extent of a bone fracture or cancerous growth. A bas-relief image of the object in question may allow a radiologist to feel the texture, depth, and approximate size of an object. A radiologist may be able to utilize the bas-relief image to more easily distinguish objects that otherwise would appear similar.

In an example, a user may identify a cancerous growth in the set of images. The user may select the cancerous growth as an object the user would like to examine via the tactile interface. The image data for the cancerous growth is analyzed to determine whether the image data has three-dimensional information. If the image data includes three-dimensional information, the image data is used to generate data for the bas-relief image of the object. If the image data does not include three-dimensional information, the three-dimensional information is simulated. The simulated three-dimensional information may then be used to generate data for the bas-relief image of the object. The data for the bas-relief image of the object is used to create the bas-relief image of the cancerous growth on the tactile interface.

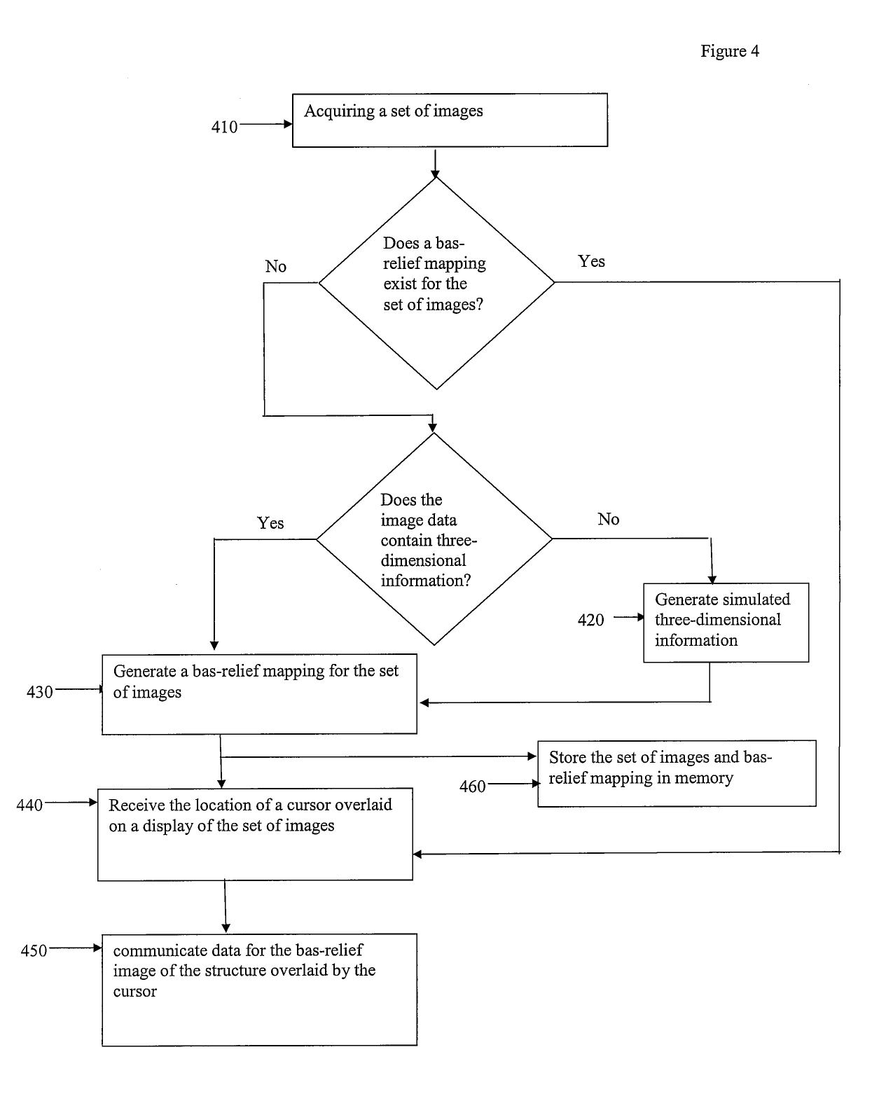

FIG. 4 illustrates a method 400 in accordance with an embodiment of the present invention. In the method 400, a bas-relief image may be created on the tactile interface as a user scrolls through the set of images. At step 410, a set of images is acquired. The set of images may have been generated from a medical diagnostic imaging system, such as an x-ray system, a computerized tomography (CT) system, an ultrasound system, an electron beam tomography (EBT) system, or a magnetic resonance (MR) system. It is contemplated that a set of images from other imaging systems may be acquired. In an embodiment, the set of images may be acquired from an external device, such as internal memory, external memory, a server, or other device.

Once the set of images is acquired, it is determined whether a bas-relief mapping exists for the set of images. A bas-relief mapping for a set of images may include the generation of data for the set of images that may be used to create a bas-relief image for the objects in a set of images. The creation of a bas-relief mapping may include processing the image data for the entire set of images prior to viewing the set of images. The data for the creation of bas-relief images for most of the objects in the set of images may then be readily available. The creation of a bas-relief mapping may initially be computationally expensive. However, depending on the application, it may provide a more user friendly experience in analyzing the set of images with the tactile interface.

If a bas-relief mapping exists for the set of images, the location of the cursor on the display may be monitored and tracked at step 440. The cursor may be overlaid onto the display of the set of images. The location of the cursor on the set of images may identify the object or structure for which a bas-relief image may be created. At step 450, the data for the bas-relief image of the object or structure overlaid by the cursor is communicated to the tactile interface. The data for the bas-relief image of the object is used to create the bas-relief image on the tactile interface.

If a bas-relief mapping does not exist for the set of images, a bas-relief mapping is created. The image data is analyzed to determine whether the image data contains three-dimensional information. Images having three-dimensional imaging data, such as images generated from an MR system, may have inherent three-dimensional information. For images having two-dimensional imaging data, three-dimensional information may be absent from the image data. At step 430, if the image data includes three-dimensional information, the image data may be used to generate a bas-relief mapping for the set of images. If the image data includes two-dimensional information, as at step 420, the computer software processes the two-dimensional information for the object to deduce or simulate three-dimensional information. The simulated three-dimensional image data may then be used at step 430 to generate a bas-relief mapping for the set of images.

Once the bas-relief mapping is created, the bas-relief mapping may be stored at step 460. The bas-relief mapping may be stored with the set of images for subsequent review. If a user wishes to review the set of images, the location of the cursor overlaid on the set of images may be received at step 440. As stated above, the cursor may be overlaid onto the display of the set of images. The location of the cursor on the set of images may identify the object or structure for which a bas-relief image may be created. At step 450, the data for the bas-relief image of the object or structure overlaid by the cursor is communicated to the tactile interface. The data for the bas-relief image of the object is used to create the bas-relief image on the tactile interface.

In an example, a user may scroll through a set of images. As the user scrolls through the set of images, the location of the on-screen cursor is monitored. The location of the on-screen cursor may be controlled by a user operating a computer mouse, keyboard, or trackball. As the cursor is moved throughout the set of images by the user, the tactile interface may continuously alter the bas-relief image depending on the object or structure the cursor is overlaid upon. In such a manner, a user does not select an object to create a bas-relief image. Rather, the user manipulates the cursor to overlay an object or structure to create a bas-relief image.

The system and methods described above may be carried out as part of a computer-readable storage medium including a set of instructions for a computer. The set of instructions may include an acquisition routine for acquiring a set of images. The set of instructions may include a display routine for displaying the set of images. The set of instructions may include a first receipt routine for receiving a selection of an object to create a bas-relief image. The set of instructions may include an analyzing routine for analyzing the image data for the selected object to determine whether the image data includes three-dimensional information. The set of instructions also includes a simulation routine for simulating the three-dimensional information if the image data does not include three-dimensional information. The set of instructions includes a first generation routine for generating data for a bas-relief image of the selected object. The set of instructions also includes a first communication routine for communicating data for the bas-relief image of the object to the tactile interface. The set of instructions may also include a creation routine for creating the bas-relief image.

The set of instructions may include a second generation routine for generating a bas-relief mapping for the set of images. The set of instructions may include a second receipt routine for receiving the location of a cursor overlaid on the display of the set of images. The set of instructions also include a tracking routine for tracking the location of a cursor overlaid on the set of images. The set of instructions may also include a second communication routine for communicating data for the bas-relief image of the structure overlaid by the cursor to the tactile interface.

Certain embodiments of the present invention provide a technical effect of creating bas-relief images of objects or structures on a tactile interface. Certain embodiments allow a radiologist to utilize the bas-relief image of the object or structure to identify surfaces and edges. Certain embodiments provide additional information for the radiologist to aid in developing a quicker and more accurate diagnosis. A bas-relief image of the object in question may allow a radiologist to feel the texture, depth, and approximate size of an object. In an embodiment, the methods described above may be operated as part of a computer software program.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims

1. A system for reviewing medical images, said system comprising:
a display unit for displaying said medical images;
an input unit for receiving input from a user;
a tactile interface to display a bas-relief image of a sub-section of said medical images; and,
a computer unit for executing computer software, said computer software controlling said display of said bas-relief image on said tactile interface.

2. The system of claim 1, wherein said tactile interface includes an array of tactile elements.

3. The system of claim 2, wherein the tactile elements of the array of tactile elements have a cylindrical shape.

4. The system of claim 2, wherein the tactile elements of the array of tactile elements are independently controlled.

5. The system of claim 4, wherein the tactile elements of the array of tactile elements may be raised or lowered independently.

6. The system of claim 1, wherein said input from a user includes the selection of an object within said medical images, said object being a sub-section of said medical images to display a bas-relief image.

7. The system of claim 6, wherein said computer software analyzes image data for said selected object to generate data to display said bas-relief image of said selected object.

8. The system of claim 1, wherein said input unit may include a computer mouse, trackball, or keyboard.

9. The system of claim 1, wherein said input from a user includes the manipulation of a cursor, said cursor displayed on said display unit as overlaid said medical images.

10. The system of claim 9, wherein said computer software analyzes image data for said object overlaid by said cursor generate data to display said bas-relief image of said object overlaid by said cursor.

11. A computer-readable storage medium including a set of instructions for a computer, the set of instructions comprising:
a receipt routine for receiving the selection of an object from a set of medical images, said object being selected by a user;
a generation routine for generating data to create a bas-relief image of said selected object; and,
a communication routine for communicating said data to create a bas-relief image of said object.

12. The set of instructions of claim 11, wherein said generation routine generates data to create a bas-relief image of said selected object based on three-dimensional information for said selected object.

13. The set of instructions of claim 12, further comprising a second generation routine for generating simulated three-dimensional information if three-dimensional information is not available for said selected object.

14. The set of instructions of claim 11, further comprising a creation routine for creating the bas-relief image.

15. The set of instructions of claim 11, wherein said set of medical images includes was generated from one of an x-ray system, a computerized tomography system, an ultrasound system, an electron beam tomography system, or a magnetic resonance system.

16. A computer-readable storage medium including a set of instructions for a computer, the set of instructions comprising:
an acquisition routine for acquiring a set of medical images;
a generation routine for generating a bas-relief map for said set of medical images, said bas-relief map containing data to create a bas-relief image for said objects of said set of medical images;
a tracking routine for tracking the location of a cursor overlaid on the set of medical images;
a communication routine for communicating data to create a bas-relief image for said objects of said set of medical images based on the objects overlaid by said cursor.

17. The set of instructions of claim 16, further comprising a storage routine for storing said set bas-relief map and said set of medical images.

18. The set of instructions of claim 16, wherein said generation routine for generating a bas-relief map includes processing the image data for the entire set of medical images to generate data to create a bas-relief image for available objects.

19. The set of instructions of claim 16, wherein said communication routine communicates data to create a bas-relief image at approximately the same time objects are overlaid by said cursor.

20. The set of instructions of claim 16, wherein said acquisition routine acquires said set of medical images from one of internal memory, external memory, or a medical diagnostic imaging system.
